(19) United States
(12) Patent Application Publication
(10) Pub. No.: US 2007/0150929 A1
(43) Pub. Date: Jun. 28, 2007

(54) Electronic apparatus and method for controlling data transfer rate in electronic apparatus

(75) Inventor: Shigeru Kizaki, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/644,972

(22) Filed: Dec. 26, 2006

(30) Foreign Application Priority Data
Dec. 26, 2005 (JP) 2005-373393

(51) Int. Cl. H04N 7/173; H04N 7/18; H04N 7/16

(52) U.S. Cl. 725/132; 725/81; 725/80; 725/140

(57) ABSTRACT

According to one embodiment, there is provided an electronic apparatus including: a processor that executes an application program for processing data; and a wireless communication unit that wirelessly transfers data to an external apparatus at a first data transfer rate, while the application program is inactive. The wireless communication unit wirelessly transfers data pursuant to the execution of the application program to the external apparatus at a second data transfer rate that is different from the first data transfer rate, while the application program is active.

### CROSS-REFERENCE TO RELATED APPLICATIONS

This application is based upon and claims the benefit of priority from Japanese Patent Application No. 2005-373393, filed Dec. 26, 2005, the entire contents of which are incorporated herein by reference.

### BACKGROUND

1. Field

One embodiment of the present invention relates to an electronic apparatus on which, for example, a communication function is mounted, and a data transfer rate controlling method in the electronic apparatus.

2. Description of the Related Art

In accordance with the development of the communication technology, recently, it becomes possible to transfer data of various types such as still image data and video data without causing any problem. There is data transfer rate which is suitable for each of various types of data, respectively. For example, it is often that a transfer rate which is necessary in transferring a still image data does not require a transfer rate which is necessary in transferring video data.

Japanese Patent Application Publication (KOKAI) No. 2004-12871 discloses a technique in which a buffer for accumulating transfer data, and a circuit for checking the accumulation degree in the buffer at constant intervals are disposed in the reception side, and the communication rate is changed in accordance with the accumulation degree of transfer data in the buffer.

In the technique, the communication rate is changed in accordance with the amount of data accumulated in the buffer, and therefore the data transfer rate cannot be adequately changed according to, for example, the type of data to be transferred.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a display unit that is opened with respect to a body according to an embodiment of the invention;

FIG. 2 is an exemplary view showing the configuration of a computer and a display apparatus that wirelessly communicates with the computer according to the embodiment;

FIG. 3 is an exemplary view showing a setting of a communication rate of a wireless LAN device according to the embodiment;

FIG. 4 is an exemplary flowchart showing a procedure of setting of the rate of data transfer that is performed when a video reproduction application is activated, according to the embodiment;

FIG. 5 is an exemplary table showing relationships between determination contents of a display driver and a data transfer rate according to the embodiment;

FIG. 6 is an exemplary flowchart showing a procedure of the setting of the rate of data transfer that is performed when the video reproduction application ends, according to the embodiment;

FIG. 7 is an exemplary flowchart showing the procedure of the setting of the rate of data transfer that is performed when reproduction of video data is started after the video reproduction application is activated, according to the embodiment;

FIG. 8 is an exemplary flowchart showing the procedure of the setting of the rate of data transfer that is performed when reproduction of video data is stopped, according to the embodiment;

FIG. 9 is an exemplary flowchart showing the procedure of the setting of the rate of data transfer which is performed when the value of the bit rate of video data reproduced by the video reproduction application is changed, according to the embodiment; and

FIG. 10 is an exemplary flowchart showing an example of the procedure of the setting of the rate of data transfer which is performed when the value of the frame rate of video data reproduced by the video reproduction application is changed, according to the embodiment.

### DETAILED DESCRIPTION

Various embodiments according to the invention will be described hereinafter with reference to the accompanying drawings. In general, according to one embodiment of the invention, there is provided an electronic apparatus including: a processor that executes an application program for processing data; and a wireless communication unit that wirelessly transfers data to an external apparatus at a first data transfer rate, while the application program is inactive. The wireless communication unit wirelessly transfers data pursuant to the execution of the application program to the external apparatus at a second data transfer rate that is different from the first data transfer rate, while the application program is active.

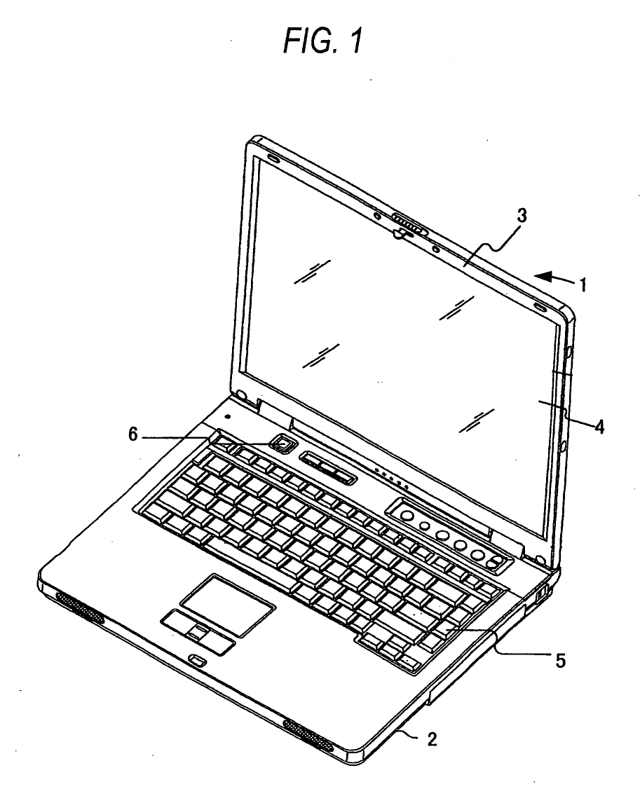

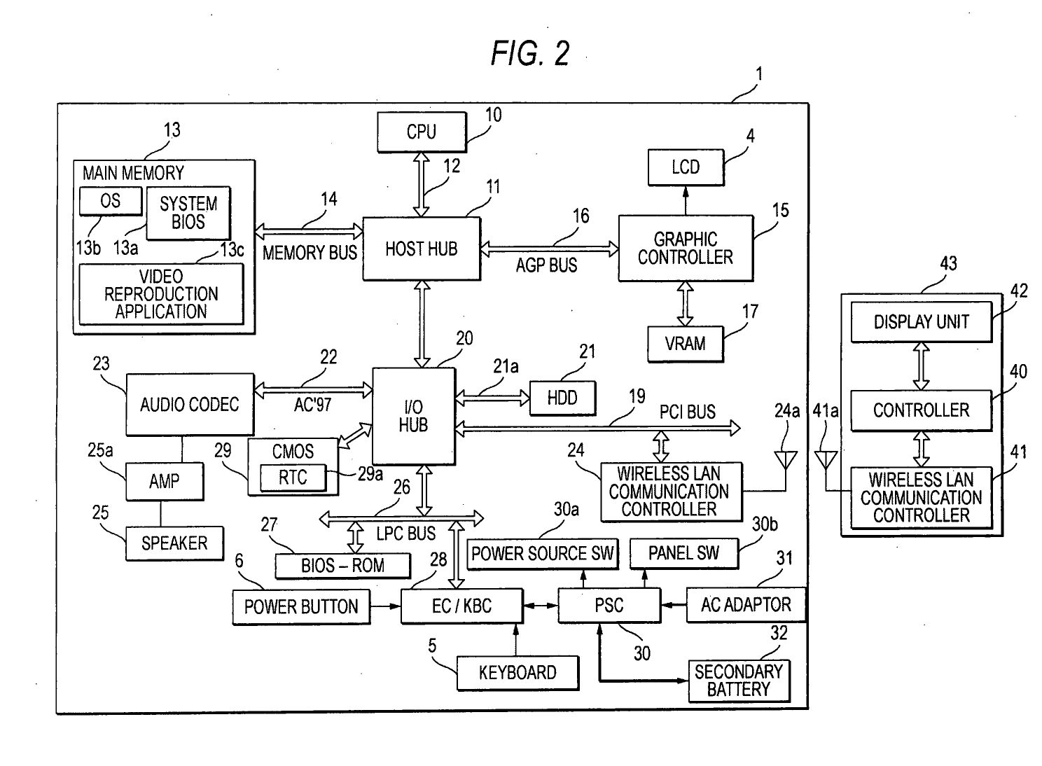

Referring to FIGS. 1 and 2, an example of the configuration of an information processing apparatus which is an embodiment of the invention will be described. The information processing apparatus is a portable information processing apparatus having a function of executing wireless communication such as a wireless LAN, and realized as a notebook type personal computer (hereinafter, referred to as computer) 1.

FIG. 1 is a perspective view showing an example of a state where a display unit 3 of the computer 1 is opened with respect to a body 2.

The computer 1 is configured by the body 2 and the display unit 3. A display device having an LCD (Liquid Crystal Display) 4 is incorporated into the display unit 3. The LCD 4 is located in a substantially middle of the display unit 3.

The display unit 3 is supported by the body 2, and attached to the body 2 so as to swing between an open position where the upper face of the body 2 is exposed, and a close position where the unit covers the upper face of the body 2. The body 2 has a substantially box-like shape. A keyboard 5, a power button 6 for turning on/off the power source of the computer 1, and the like are placed on the upper face of the body 2. The power button 6 is depressed to start the use of the computer 1.

As described later in detail, a wireless communication device which realizes a wireless communication function is attached to the computer 1. The computer 1 can wirelessly communicate with a display apparatus having a wireless communication function, so that data reproduced by the computer 1 can be wirelessly transmitted to the display apparatus. Next, the system configuration of the computer 1 will be described.

FIG. 2 is a view showing an example of the system configuration of the computer 1 and a display apparatus 43 which wirelessly communicates with the computer 1.

A CPU 10, a main memory 13, a graphic controller 15, and an I/O (Input/Output) hub 20 are connected to a host hub (first bridge circuit) 11.

The host hub 11 is connected to the CPU 10 via a system bus 12. The host hub 11 incorporates a memory controller which controls the access to the main memory 13.

The CPU 10 is a main processor which controls the system of the computer 1. The CPU 10 executes an operating system (OS) 13b, a video reproduction application 13c, and the like which are loaded to the main memory 13 via a memory bus 14 from an HDD 21 that is an external storage device. The video reproduction application 13c will be described later.

The CPU 10 further executes a System BIOS (Basic Input Output System) 13a which is loaded to the main memory 13 from a BIOS-ROM 27.

The graphic controller 15 which is connected to the host hub 11 via an AGP (Accelerated Graphics Port) bus 16 supplies a digital display signal to the LCD 4. A video memory (VRAM) 17 is connected to the graphic controller 15. The graphic controller 15 displays data which are written into the video memory 17 by the OS/application program, on the LCD 4.

An I/O hub (second bridge circuit) 20 which connected to the host hub 11 through-a dedicated bus such as a hub interface controls devices connected to an LPC (Low Pin Count) bus 26, and devices connected to a PCI (Peripheral Component Interconnect) bus 19.

The I/O hub 20 incorporates a serial ATA (AT Attachment) controller for controlling an HDD 117. The I/O hub 20 is connected to the HDD 21 which is an external storage device, and which supports the serial ATA standard, via a serial ATA bus 21a which supports the serial ATA standard.

The HDD (magnetic disk device) 21 is a magnetic disk device. The HDD 21 stores data which are produced by using the operating system (OS) 13b and application programs, and the like.

An audio codec 23 and a CMOS 29 are connected to the I/O hub 20.

The audio codec 23 is connected to the I/O hub 20 via an AC (Audio Codec) 97 (22). The audio codec 23 is one kind of a codec for inputting and outputting sound data. The audio codec 23 has a codec portion for input and output sound data, etc.

An amplifier (AMP) 25a is connected to the audio codec 23. The AMP 25a amplifies a sound signal produced by the audio codec 23. The sound signal which is amplified by the AMP 25a is supplied to a speaker 25. The speaker outputs a sound wave of the audible frequency range.

The CMOS (Complementary Metal-Oxide Semiconductor) 29 incorporates an RTC (Real Time Clock) 29a. The RTC 29a is a module which counts the date and time, and operates with using the power source that is supplied from an internal battery or the like even when the system power source is turned off.

The CMOS 29 stores preset contents and the like which are designated on a Setup screen of the BIOS.

A wireless LAN device 24 is connected to the PCI bus 19.

The wireless LAN communication controller 24 is a wireless communication controller which corresponds to the IEEE 802.11 standard or the like, and executes a control of wireless communication with an external apparatus with using a frequency band such as the ISM (Industrial Scientific and Medical) band of 2.4 GHz band, 5.2 GHz band, or the like. One of control contents of the wireless communication is a change of the rate of data transfer with an external apparatus. The control of the change of the data transfer rate will be described later. An antenna 24a is connected to the wireless LAN communication controller 24. The antenna 24a transmits a radio wave for wireless communication to an external electronic apparatus, and receives a radio wave for wireless communication from the external electronic apparatus.

The BIOS-ROM 27 and an embedded controller/keyboard controller IC (EC/KBC) 28 are connected to the LPC bus 26.

The BIOS-ROM 27 is a storage medium which stores the System BIOS 13a, and the like. The storage medium which is used as the BIOS-ROM 27 is a storage medium on which a program is rewritable, such as a flash memory.

The System BIOS 13a is a program in which function executing routines for accessing various hardware devices are systemized.

The embedded controller/keyboard controller IC (EC/KBC) 28 is a one-chip microcomputer in which an embedded controller for performing power management and the like, and a keyboard controller for controlling the keyboard (KB) unit 5 are integrated with each other.

The keyboard 5, the power button 6, and a PSC (Power Supply Controller) 30 are connected to the EC/KBC 28.

The EC/KBC 28 has a power source sequence control function which cooperates with the PSC 30 to control turning on/off of the system power source, and a function of notifying the power source status. In any status of the power source of the computer 1, the power is always supplied to the EC/KBC 28.

The function of notifying the power source status is a function which cooperates with the PSC 30 to monitor an occurrence of a wakeup event causing a start of a resume processing routine, and which uses the SMI (System Management Interrupt) at an occurrence of a wakeup event to notify that an event occurs, to the System BIOS 13a.

Examples of the wakeup event are a turn-on of a power source switch 30a in response to a depressing operation of the power button 6, and that of a panel switch 30b in response to an operation of changing the display unit 3 from the close state to the open state with respect to the body 2.

The EC/KBC 28 has an I/O port for communicating with the System BIOS 13a. The System BIOS 13a performs a read/write operation on a configuration register which is disposed in the EC/KBC 28 via the I/O port, thereby reading and monitoring a status indicating an occurring event, and setting the kind of a notified event. The communication between the EC/KBC 28 and the PSC 30 is performed through an I2C bus.

The PSC 30 which is a power source controlling portion supplies an electric power fed from an AC adaptor 31 or a secondary battery 32 to the modules of the computer 1. The secondary battery 32 is detachably disposed. When the power source is supplied from the AC adaptor 31 to the computer 1, the electric power supplied from the AC adaptor 31 is stored in the secondary battery 32 via the PSC 30.

When the user operates the power button 6, the EC/KBC 28 detects that the power button 6 is depressed. When detecting that the power button 6 is depressed, the EC/KBC 28 notifies the PSC 30 that the power supply to, for example, the system of the computer 1 starts. Based on the notification from the EC/KBC 28, the PSC 30 controls the power supply from the AC adaptor 31 or the secondary battery 32 to the system of the computer 1 to start.

The display apparatus 43 which can wirelessly communicate with the computer 1 is configured by a controller 40, a wireless LAN communication controller 41, and a display unit 42.

The controller 40 is a processor which controls the system of the display apparatus 43. The wireless LAN communication controller 41 and the display unit 42 are connected to the controller 40.

The wireless LAN communication controller 41 is a wireless communication controller which corresponds to the IEEE 802.11 standard or the like, and executes a control of wireless communication with an external apparatus with using a frequency band such as the ISM (Industrial Scientific and Medical) band of 2.4 GHz band, 5.2 GHz band, or the like. One of control contents of the wireless communication is a change of the rate of data transfer with an external apparatus.

The wireless LAN communication controller 41 wirelessly communicates with the wireless LAN communication controller 24 attached to the computer 1. The wireless LAN communication controller 41 receives data which are wirelessly transferred from the wireless LAN communication controller 24 of the computer 1. An antenna 41a is connected to the wireless LAN communication controller 41. The antenna 41a transmits a radio wave for wireless communication to an external electronic apparatus, and receives a radio wave for wireless communication from the external electronic apparatus.

In the case where the wireless LAN communication controller 41 receives data which are transferred from an external apparatus, the data transfer rate is changed by the wireless LAN communication controller 41 in the following manner.

In the case where data are wirelessly transferred from the wireless LAN communication controller 24 to the wireless LAN communication controller 41 and the data transfer rate is changed on the transmission side or the wireless LAN communication controller 24, for example, the wireless LAN communication controller 41 which is the reception side receives information related to the data transfer rate change (for example, the value of the data transfer rate after a change) from the wireless LAN communication controller 24 which is the transmission side. On the basis of the received information, the rate of the data transfer after a change is set in the wireless LAN communication controller 41.

The controller 40 displays data which are transferred from the computer 1 and received by the wireless LAN communication controller 41, on the display unit 42. The setting of the communication rate of the wireless LAN communication controller 24 will be described.

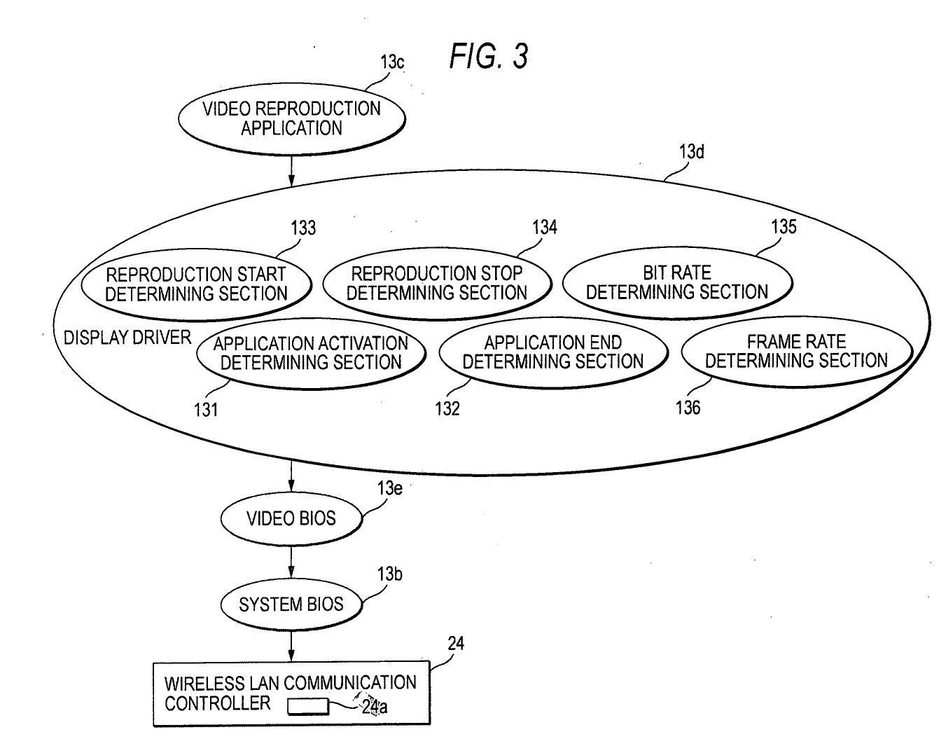

FIG. 3 is a view showing an example of the setting of the communication rate of the wireless LAN device 24.

When a predetermined event occurs, the video reproduction application 13c notifies a display driver 13d of a message indicating that the predetermined event occurs.

Based on the message sent from the video reproduction application 13c, the display driver 13d determines which kind of events occurs.

The display driver 13d has an application activation determining section 131, an application end determining section 132, a data reproduction start determining section 133, a data reproduction stop determining section 134, a bit rate determining section 135, and a frame rate determining section 136. As described later in detail, the determining sections 131 to 136 determine the kind of the occurring event related to the video reproduction application 13c.

The determination content of the display driver 13d is notified to the System BIOS 13a via the Video BIOS 13e.

Based on the determination content of the display driver 13d, the System BIOS 13a selects the rate of data transfer which is controlled by the wireless LAN communication controller 24. The System BIOS 13a has a table showing relationships between the determination content of the display driver 13d and the data transfer rate. The relationships between the determination content of the display driver 13d and the data transfer

The System BIOS 13a set-s the selected data transfer rate into a register 24b of the wireless LAN communication controller 24. When the data rate is set into the register 24b by the System BIOS 13a, the rate of data transferred by the wireless LAN communication controller 24 is become equal to the data rate which is set in the register 24b. Next, the procedure of the setting of the data transfer rate which is performed when the video reproduction application 13c is activated will be described.

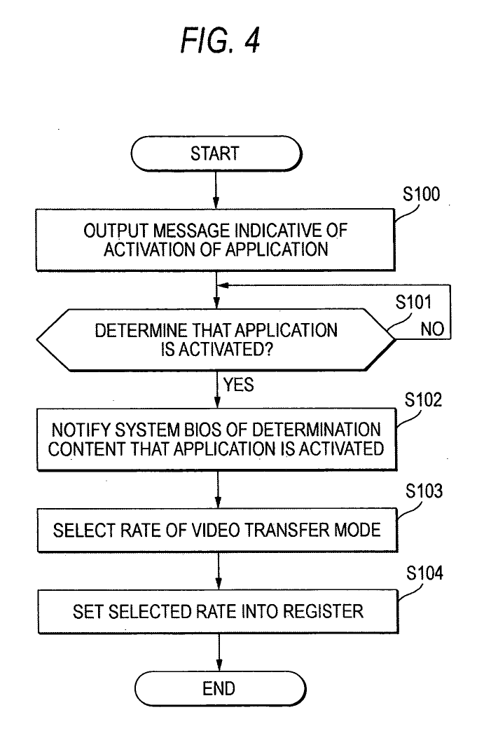

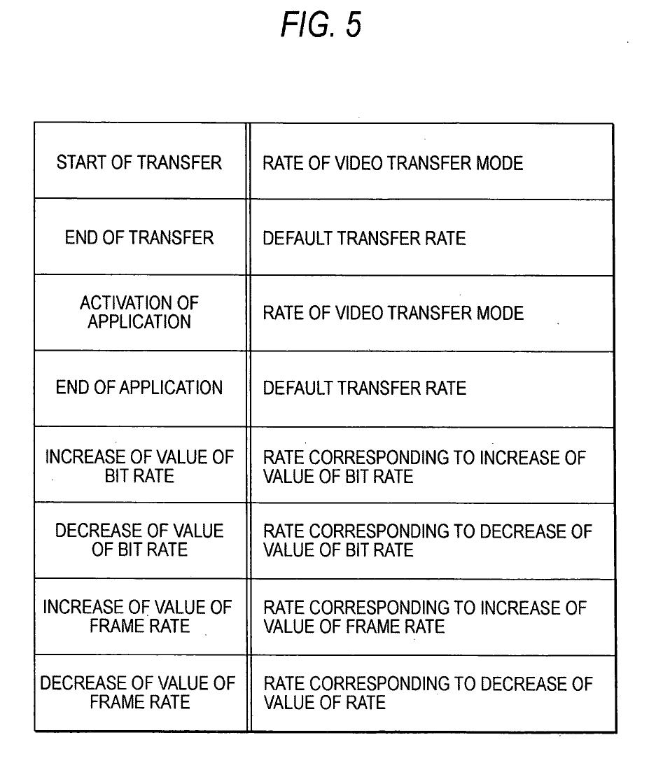

FIG. 4 is a flowchart showing an example of the procedure of the setting of the rate of data transfer which is performed when the video reproduction application 13c is activated. FIG. 5 is a table showing an example of the relationships between the determination contents of the display driver 13d and the data transfer rate.

When the video reproduction application 13c is activated by the CPU 10, a message indicating that the video reproduction application 13c is activated is output to the display driver 13d (block S100).

On the basis of the message indicating that the video reproduction application 13c is activated, the application activation determining section 131 included in the display driver 13d determines that the video reproduction application 13c is activated (Yes in block S101).

The determination content that the video reproduction application 13c is activated is notified to the System BIOS 13a from the display driver 13d via the Video BIOS 13e (block S102).

Based on the determination content that the video reproduction application 13c is activated, the System BIOS 13a selects the transfer rate of data to be transferred by the wireless LAN communication controller 24. The System BIOS 13a has a table which is shown in, for example, FIG. 5, and which indicates the relationships between the determination content of the display driver 13d and the data transfer rate. Referring to the table, the System BIOS 13a selects the rate of data transfer which is controlled by the wireless LAN communication controller 24. Based on the contents of the table shown in FIG. 5, the System BIOS 13a selects the rate of data transfer in a video transfer mode (block S103).

In order to set the rate of data transfer which is controlled by the wireless LAN communication controller 24 to that of data transfer in the video transfer mode, the System BIOS 13a sets the rate of data transfer in the video transfer mode into the register 24b of the wireless LAN communication controller 24 (block S104). Next, the procedure of the setting of the data transfer rate which is performed when the video reproduction application 13c ends will be described.

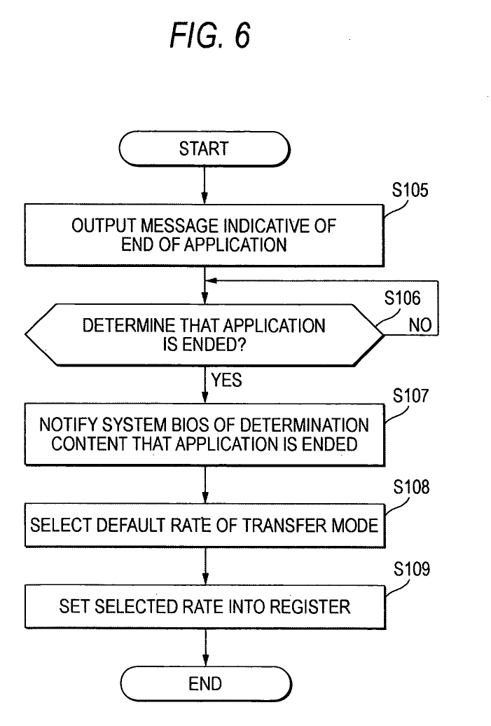

FIG. 6 is a flowchart showing an example of the procedure of the setting of the rate of data transfer which is performed when the video reproduction application 13c ends.

When the video reproduction application 13c is ended by the CPU 10, the video reproduction application 13c outputs a message indicative of the end to the display driver 13d (block S105).

On the basis of the message indicating that the video reproduction application 13c ends, the application end determining section 132 included in the display driver 13d determines that the video reproduction application 13c ends (Yes in block S106).

The determination content that the video reproduction application 13c ends is notified to the System BIOS 13a from the display driver 13d via the Video BIOS 13e (block S107).

Based on the determination content that the video reproduction application 13c ends, the System BIOS 13a selects the rate of data transfer which is controlled by the wireless LAN communication controller 24. Referring to the table shown in FIG. 5, the System BIOS 13a selects the rate of data transfer which is controlled by the wireless LAN communication controller 24. Based on the contents of the table shown in FIG. 5, the System BIOS 13a selects the default rate of data transfer (block S108). As the default data transfer rate, a rate which is different from that of the data transfer in the video transfer mode, such as a data transfer rate in a still-image transfer mode which has a value smaller than that of the data transfer rate in the video transfer mode may be used.

In order to set the rate of data transfer which is controlled by the wireless LAN communication controller 24 to the default data transfer rate, the System BIOS 13a sets the default data transfer rate into the register 24b of the wireless LAN communication controller 24 (block S109).

As described with reference to FIGS. 4 to 6, in order to prepare for transferring video data reproduced by the activated video reproduction application 13c to the transmission destination by the wireless LAN communication controller 24, when the video reproduction application 13c is activated, the rate of data transfer which is controlled by the wireless LAN communication controller 24 is set to that of data transfer in the video transfer mode. Therefore, a process of transferring video data can be executed without causing any problem.

When the video reproduction application 13c is ended, the rate of data transfer which is controlled by the wireless LAN communication controller 24 is set to, for example, the data transfer rate in the still-image transfer mode which has a value smaller than that of the data transfer rate in the video transfer mode, thereby enabling power saving. Next, the procedure of the setting of the data transfer rate in the case where reproduction of video data is started after the video reproduction application 13c is activated will be described.

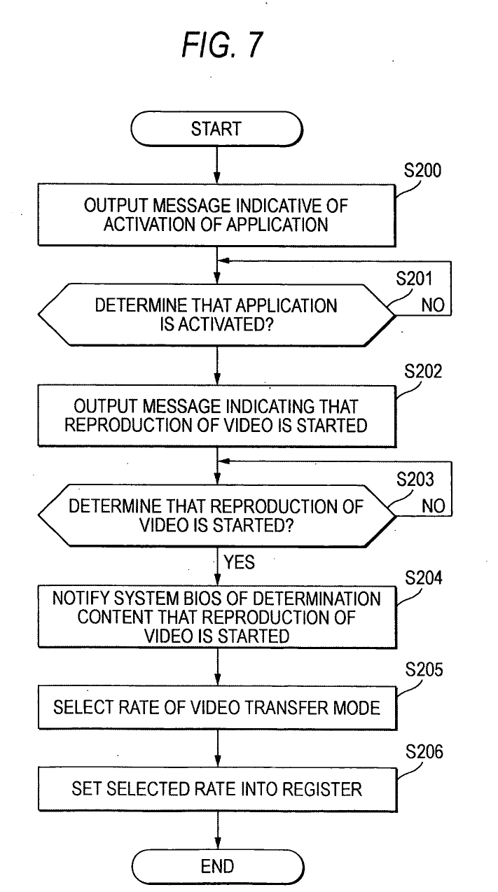

FIG. 7 is a flowchart showing an example of the procedure of the setting of the rate of data transfer which is performed when reproduction of video data is started after the video reproduction application 13c is activated.

When the video reproduction application 13c is activated by the CPU 10, the video reproduction application 13c outputs a message indicative of the activation to the display driver 13d (block S200).

On the basis of the message indicating that the video reproduction application 13c is activated, the application activation determining section 131 included in the display driver 13d determines that the video reproduction application 13c is activated (Yes in block S201).

When the video reproduction application 13c starts reproduction of video data, the video reproduction application 13c outputs a message indicating that reproduction of video data is started, to the display driver 13d (block S202).

On the basis of the message indicating that reproduction of video data is started, the data reproduction start determining section 133 included in the display driver 13d determines that the video reproduction application 13c starts reproduction of video data (Yes in block S203).

The determination content that reproduction of video data is started is notified from the display driver 13d to the System BIOS 13a via the Video BIOS 13e (block S204).

Based on the determination content that reproduction of video data is started, the System BIOS 13a selects the rate of data transfer which is controlled by the wireless LAN communication controller 24. Referring to the table shown in FIG. 5, the System BIOS 13a selects the rate of data transfer which is controlled by the wireless LAN communication controller 24. Based on the contents of the table shown in FIG. 5, the System BIOS 13a selects the rate of data transfer in the video transfer mode (block S205).

In order to set the rate of data transfer which is controlled by the wireless LAN communication controller 24 to that of data transfer in the video transfer mode, the System BIOS 13a sets the rate of data transfer in the video transfer mode into the register 24b of the wireless LAN communication controller 24 (block S206). Next, the procedure of the setting of the data transfer rate which is performed when reproduction of video data is stopped will be described.

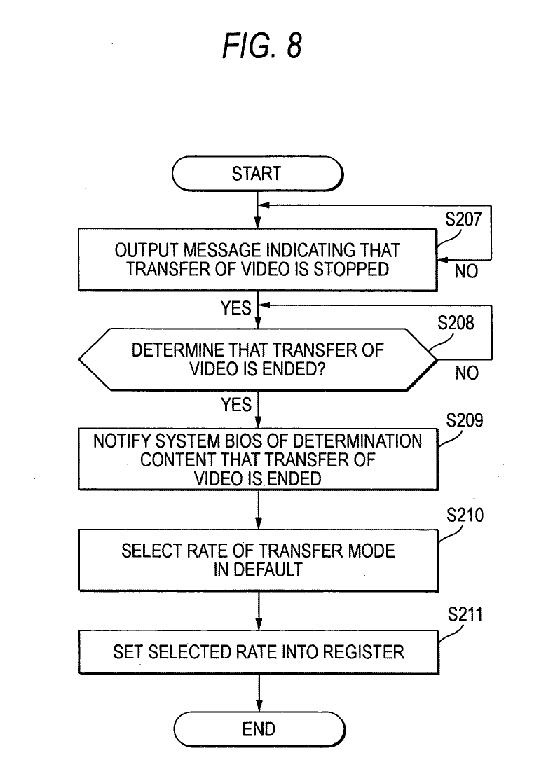

FIG. 8 is a flowchart showing an example of the procedure of the setting of the rate of data transfer which is performed when reproduction of video data is stopped.

When the video reproduction application 13c stops reproduction of video data, the video reproduction application 13c outputs a message indicating that reproduction of video data is stopped, to the display driver 13d (block S207).

On the basis of the message indicating that reproduction of video data is stopped, the data reproduction stop determining section 134 included in the display driver 13d determines that the video reproduction application 13c stops reproduction of video data (Yes in block S208).

The determination content that reproduction of video data is stopped is notified to the System BIOS 13a from the display driver 13d via the Video BIOS 13e (block S209).

Based on the determination content that reproduction of video data is stopped, the System BIOS 13a selects the rate of data transfer which is controlled by the wireless LAN communication controller 24. Referring to the table shown in FIG. 5, the System BIOS 13a selects the rate of data transfer which is controlled by the wireless LAN communication controller 24. Based on the contents of the table shown in FIG. 5, the System BIOS 13a selects the default rate of data transfer (block S210). As the default data transfer rate, for example, a rate which is different from that of the data transfer in the video transfer mode, or a data transfer rate in the still image transfer mode which has a value smaller than that of the data transfer rate in the video transfer mode may be used.

In order to set the rate of data transfer which is controlled by the wireless LAN communication controller 24 to the default data transfer rate, the System BIOS 13a sets the data transfer rate in the video transfer mode into the register 24b of the wireless LAN communication controller 24 (block S211).

As described with reference to FIGS. 5, 7, and 8, when the video reproduction application 13c starts reproduction of video data, the rate of data transfer which is controlled by the wireless LAN communication controller 24 is set to the data transfer rate in the video transfer, whereby the process of transferring video data can be executed without causing any problem.

When the video reproduction application 13c stops reproduction of video data, the rate of data transfer which is controlled by the wireless LAN communication controller 24 is set to the data transfer rate in the still image transfer mode which has a value smaller than that of the data transfer rate in the video transfer mode, thereby enabling power saving. Next, the procedure of the setting of the data transfer rate in the case where the value of the bit rate of video data reproduced by the video reproduction application 13c is changed will be described.

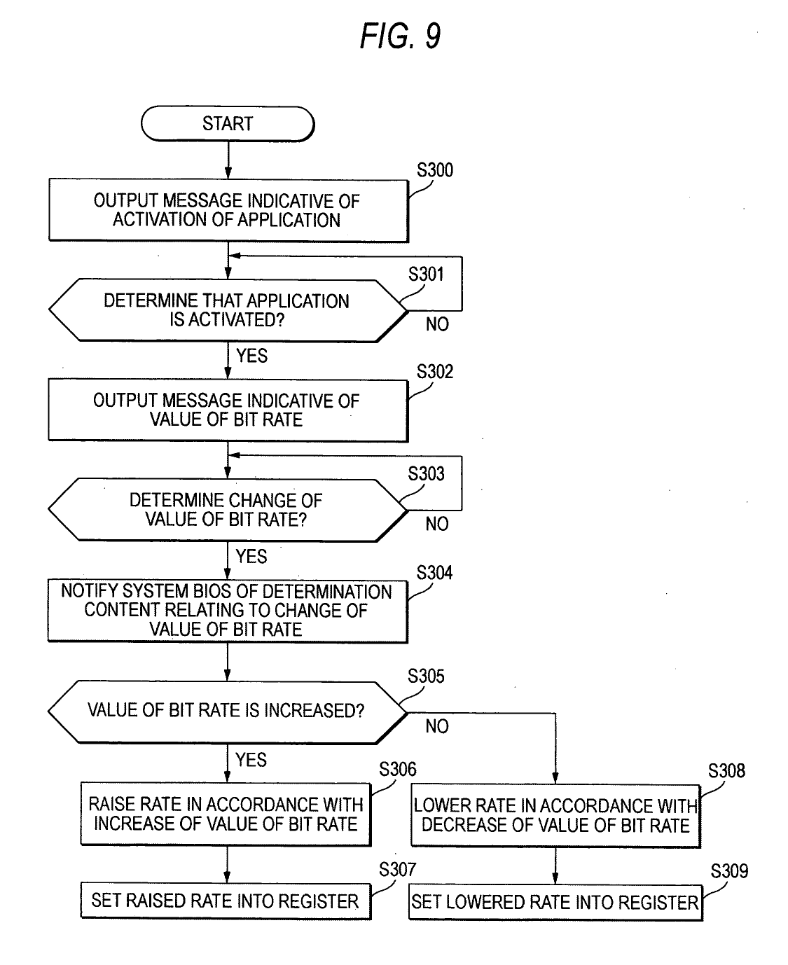

FIG. 9 is a flowchart showing an example of the procedure of the setting of the data transfer rate which is performed when the value of the bit rate of video data reproduced by the video reproduction application 13c is changed.

When the video reproduction application 13c is activated by the CPU 10, the video reproduction application 13c outputs a message indicative of the activation to the display driver 13d (block S300).

On the basis of the message indicating that the video reproduction application 13c is activated, the application activation determining section 131 included in the display driver 13d determines that the video reproduction application 13c is activated (Yes in block S301).

When the bit rate of reproduced video data is changed, the video reproduction application 13c outputs a message indicative of the value of the changed video data bit rate to the display driver 13d (block S302).

On the basis of the value of the changed video data bit rate and that of the video data bit rate before the change, the bit rate determining section 135 included in the display driver 13d determines whether the value of the bit rate of reproduced video data reproduced by the video reproduction application 13c is increased or decreased (Yes in block S303).

The determination content relating to the change of the bit rate of video data (the content indicating whether the value of the bit rate is increase or decreased) is notified from the display driver 13d to the System BIOS 13a via the Video BIOS 13e (block S304).

Based on the determination content relating to the change of the bit rate of video data, the System BIOS 13a selects the rate of data transfer which is controlled by the wireless LAN communication controller 24. Referring to the table shown in FIG. 5, the System BIOS 13a controls the rate change of data transfer which is controlled by the wireless LAN communication controller 24. Based on the contents of the table shown in FIG. 5, when the value of the bit rate of video data is increased (Yes in block S305), the System BIOS 13a raises the rate of data transfer in the video transfer mode (block S306).

In order to set the rate of data transfer which is controlled by the wireless LAN communication controller 24 to the raised rate of data transfer, the System BIOS 13a sets the raised rate of data transfer into the register 24b of the wireless LAN communication controller 24 (block S307).

By contrast, based on the contents of the table shown in FIG. 5, when the value of the bit rate of video data is decreased (No in block S305), the System BIOS 13a lowers the rate of data transfer in the video transfer mode (block S308).

In order to set the rate of data transfer which is controlled by the wireless LAN communication controller 24 to the lowered data transfer rate, the System BIOS 13a sets the lowered data transfer rate into the register 24b of the wireless LAN communication controller 24 (block S309).

As described with reference to FIGS. 5 and 9, when the value of the bit rate of video data reproduced by the video reproduction application 13c is changed, also the rate of data transfer which is controlled by the wireless LAN communication controller 24 is changed. More specifically, when the value of the bit rate of video data reproduced by the video reproduction application 13c is increased, also the rate of data transfer which is controlled by the wireless LAN communication controller 24 is increased, whereby the process of transferring video data can be executed without causing any problem.

When the value of the bit rate of video data reproduced by the video reproduction application 13c is decreased, also that of the rate of data transfer which is controlled by the wireless LAN communication controller 24 is decreased, thereby enabling power saving. Next, the procedure of the setting of the data transfer rate in the case where the frame rate of video data reproduced by the video reproduction application 13c is changed will be described.

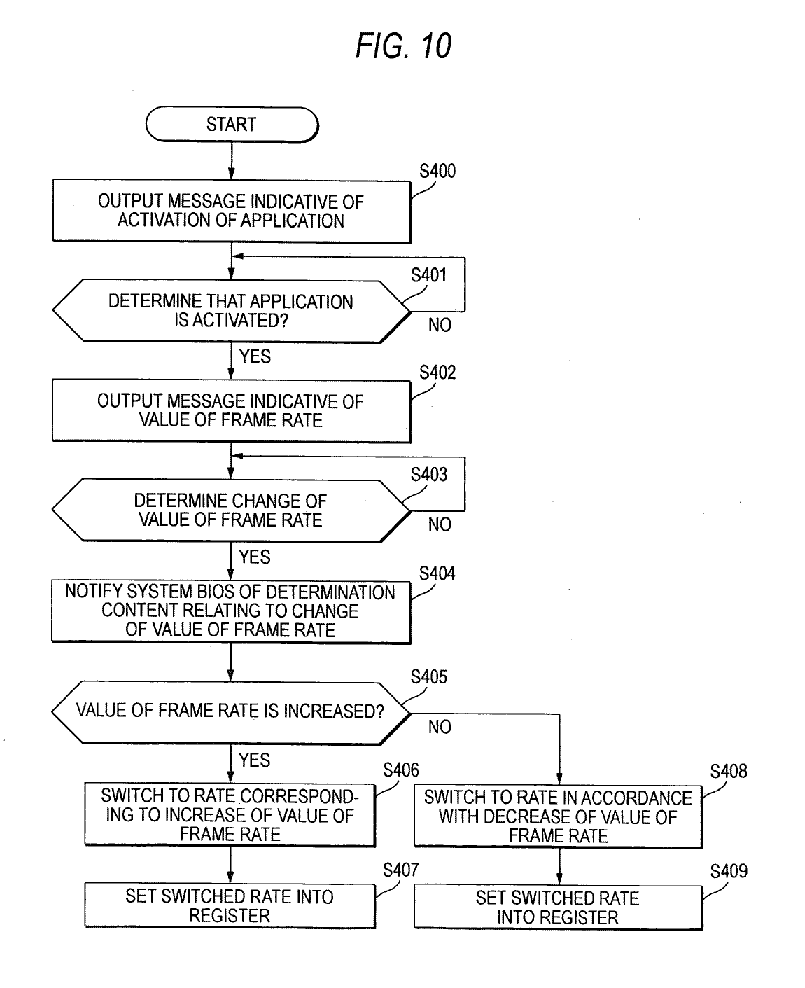

FIG. 10 is a flowchart showing an example of the procedure of the setting of the rate of data transfer which is performed when the value of the frame rate of video data reproduced by the video reproduction application 13c is changed.

When the video reproduction application 13c is activated by the CPU 10, the video reproduction application 13c outputs a message indicative of the activation to the display driver 13d (block S400).

On the basis of the message indicating that the video reproduction application 13c is activated, the application activation determining section 131 included in the display driver 13d determines that the video reproduction application 13c is activated (Yes in block S401).

When the frame rate of reproduced video data is changed, the video reproduction application 13c outputs a message indicative of the value of the changed video data frame rate to the display driver 13d (block S402).

On the basis of the value of the changed video data frame rate and that of the video data frame rate before the change, the frame rate determining section 136 included in the display driver 13d determines whether the value of the frame rate of video data reproduced by the video reproduction application 13c is increased or decreased (Yes in block S403).

The determination content relating to the change of the frame rate of video data (the content indicating whether the value of the frame rate is increased or decreased) is notified from the display driver 13d to the System BIOS 13a via the Video BIOS 13e (block S404).

Based on the determination content relating to the change of the frame rate of video data, the System BIOS 13a selects the rate of data transfer which is controlled by the wireless LAN communication controller 24. Referring to the table shown in FIG. 5, the System BIOS 13a controls the rate change of data transfer which is controlled by the wireless LAN communication controller 24. Based on the contents of the table shown in FIG. 5, when the value of the frame rate of video data is increased (Yes in block S405), the System BIOS 13a switches the rate of data transfer to that which is optimum to transfer video data having the value of the changed frame rate (block S406).

In order to set the rate of data transfer which is controlled by the wireless LAN communication controller 24 to that which is optimum to transfer video data having the value of the changed frame rate, the System BIOS 13a sets the rate which is optimum to transfer video data having the value of the changed frame rate, into the register 24b of the wireless LAN communication controller 24 (block S407).

By contrast, based on the contents of the table shown in FIG. 5, when the value of the frame rate of video data is decreased (No in block S405), the System BIOS 13a switches the rate of data transfer to that which is optimum to transfer video data having the value of the changed frame rate (block S408).

In order to set the data transfer rate which is controlled by the wireless LAN communication controller 24 to that which is optimum to transfer video data having the value of the changed frame rate, the System BIOS 13a sets the data transfer rate which is optimum to transfer video data having the value of the changed frame rate, into the register 24b of the wireless LAN communication controller 24 (block S409).

As described with reference to FIGS. 5 and 10, when the value of the frame rate of video data reproduced by the video reproduction application 13c is changed, also the rate of data transfer which is controlled by the wireless LAN communication controller 24 is changed. More specifically, when the value of the bit rate of video data reproduced by the video reproduction application 13c is increased, the rate of data transfer which is controlled by the wireless LAN communication controller 24 is changed to that which is optimum to transfer video data having the value of the changed frame rate, whereby the process of transferring video data can be executed without causing any problem.

When the value of the frame rate of video data reproduced by the video reproduction application 13c is decreased, the rate of data transfer which is controlled by the wireless LAN communication controller 24 is set to the data transfer rate which is optimum to transfer video data having the value of the changed frame rate, whereby the process of transferring video data can be executed without causing any problem.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. An electronic apparatus comprising:
a processor that executes an application program for processing data; and
a wireless communication unit that wirelessly transfers data to an external apparatus at a first data transfer rate, while the application program is inactive,
wherein the wireless communication unit wirelessly transfers data pursuant to the execution of the application program to the external apparatus at a second data transfer rate that is different from the first data transfer rate, while the application program is active.

2. The electronic apparatus according to claim 1, wherein the wireless communication unit wirelessly transfers data to the external apparatus at the first data transfer rate when the application program is terminated.

3. The electronic apparatus according to claim 1,
wherein the wireless communication unit wirelessly transfers data processed by the processor to the external apparatus at the second data transfer rate after the application program is executed, and
wherein the wireless communication unit wirelessly transfers data to the external apparatus at the first data transfer rate when the transfer of the data processed by the processor ends.

4. The electronic apparatus according to claim 1,
wherein the wireless communication unit raises the second data transfer rate to the external apparatus when a bit rate of data to be transferred to the external apparatus is higher than that of data previously transferred to the external apparatus, and
wherein the wireless communication unit lowers the second data transfer rate to the external apparatus when the bit rate of the data to be transferred to the external apparatus is lower than that of the data previously transferred to the external apparatus.

5. The electronic apparatus according to claim 1, wherein the wireless communication unit changes the second data transfer rate to the external apparatus in accordance with a change in a frame rate of data to be transferred to the external apparatus.

6. The electronic apparatus according to claim 1,
wherein the application program is for reproducing video data, and
wherein the second data transfer rate is higher than the first data transfer rate.

7. The electronic apparatus according to claim 6,
wherein the wireless communication unit wirelessly transfers data to the external apparatus at the first data transfer rate when the application program is terminated.

8. The electronic apparatus according to claim 6,
wherein the wireless communication unit wirelessly transfers video data reproduced by the processor to the external apparatus at the second data transfer rate after the application program is executed, and
wherein the wireless communication unit wirelessly transfers data to the external apparatus at the first data transfer rate when the transfer of the video data reproduced by the processor ends.

9. An electronic apparatus comprising:
a processor that executes an application program for processing data; and
a wireless communication unit that wirelessly transfers data to an external apparatus at a first data transfer rate,
wherein, while data is processed by the processor, the wireless communication unit wirelessly transfers the processed data to the external apparatus at a second data transfer rate.

10. The electronic apparatus according to claim 9,
wherein the wireless communication unit wirelessly transfers data to the external apparatus at the first data transfer rate when the transfer of the processed data to the external apparatus ends.

11. The electronic apparatus according to claim 9,
wherein the wireless communication unit raises the second data transfer rate to the external apparatus when a bit rate of data to be transferred to the external apparatus is higher than that of data previously transferred to the external apparatus, and
wherein the wireless communication unit lowers the second data transfer rate to the external apparatus when the bit rate of the data to be transferred to the external apparatus is lower than that of the data previously transferred to the external apparatus.

12. The electronic apparatus according to claim 9, wherein the wireless communication unit changes the second data transfer rate to the external apparatus in accordance with a change in a frame rate of data to be transferred to the external apparatus.

13. The electronic apparatus according to claim 9,
wherein the processor reproduces video data, and
wherein the second data transfer rate is higher than the first data transfer rate.

14. The electronic apparatus according to claim 13,
wherein the wireless communication unit wirelessly transfers the video data to the external apparatus at the second data transfer rate when the wireless communication unit transfers the reproduced-video data to the external apparatus, and
wherein the wireless communication unit transfers data to the external apparatus at the first data transfer rate when the data transfer to the external apparatus is ended.

15. A method for controlling a data transfer rate in an electronic apparatus that is capable of wirelessly communicating with an external apparatus, the method comprising:
executing an application program for processing data; and
transferring data to the external apparatus at a second data transfer rate, while the application program is active,
wherein the second data transfer rate is different from a first data transfer rate at which data transfer to the external apparatus is performed while the application is inactive.

16. The method according to claim 15, further comprising transferring data to the external apparatus at the first data transfer rate when the application program is terminated.

17. The method according to claim 15,
wherein the processed data is transferred to the external apparatus at the second data transfer rate after the application program is executed, and
wherein the data is transferred to the external apparatus at the first data transfer rate when the transfer of the processed data ends.
